(19) United States
(12) Patent Application Publication
(10) Pub. No.: US 2006/0162196 A1
(43) Pub. Date: Jul. 27, 2006

(54) Method and apparatus for issuing temporary license plates

(76) Inventor: Karl J. Kaiser, Orlando, FL (US)

Correspondence Address: JOHNSON & STAINBROOK, LLP;Suite 203, 3558 Round Barn Blvd., Santa Rosa, CA, 95403, US

(21) Appl. No.: 11/342,144

(22) Filed: Jan. 27, 2006

Related U.S. Application Data
(60) Provisional application No. 60/647,566, filed on Jan. 27, 2005.

(51) Int. Cl. G09F 13/16

(52) U.S. Cl. 40/208

(57) ABSTRACT

A method and apparatus for issuing temporary license plates provides state governments with an electronic temporary tag registration and management system for motor vehicle dealers and tax collectors. The inventive system allows real time record retrieval of vehicle and owner information from a temporary tag, and facilitates motor vehicle dealer's compliance requirements with their states.

### CROSS REFERENCE TO RELATED APPLICATIONS

The present application claims the benefit of the filing date of U.S. Provisional Patent Application Ser. No. 60/647,566, filed 27 Jan. 2005.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to vehicle license plates and vehicle registration, and more particularly to an improved method and apparatus for the issuance of temporary license plates for motor vehicles.

### BACKGROUND INFORMATION AND DISCUSSION OF RELATED ART

The present system for the issuance of temporary license plates for vehicles is an antiquated paper driven system that has long caused breaches in homeland security, aided drug trafficking and put law enforcement at unnecessary risk. Currently, temporary tags issued by car dealers do not allow law enforcement to identify the registrant of a vehicle, but can only identify the dealership that sold the vehicle.

Current temporary tag systems invite abuse due to illegal creation, illegal duplication, unregulated distribution, lack of useful identification numbers, and absence of an identifiable expiration date. Criminals use temporary tags to avoid detection by law enforcement. The abuse of temporary license plates contributes to the lack of safety for police officers, facilitates criminal life styles, and causes millions of dollars in lost revenues for government. In addition, it costs insurers, and by extension law-abiding citizens, millions of dollars.

Many notorious criminals have been captured simply because law enforcement was able to access the motor vehicle records of a permanent license plate during a routine traffic stop. Temporary tags, however, do not readily provide law enforcement with information about the owner of a vehicle.

Procedures to provide and track temporary tags have not kept pace with advancements of modern technology. Current permanent plate systems have been upgraded many times. They now include images to deter forged versions, have color and number coded night reflective stickers to show accurate and up to date registration clearly, and are backed by computer tracking mechanisms that allow detailed information about the vehicle owner on demand.

The foregoing information reflects the current state of the art of which the present inventor is aware. Reference to, and discussion of, this information patent is intended to aid in discharging Applicant's acknowledged duty of candor in disclosing information that may be relevant to the examination of claims to the present invention. However, it is respectfully submitted that none of the above information discloses, teaches, suggests, shows, or otherwise renders obvious, either singly or when considered in combination, the invention described and claimed herein.

### SUMMARY OF THE INVENTION

The method and apparatus for issuing temporary license plates of the present invention provides state governments with an electronic temporary tag registration and management system for motor vehicle dealers and tax collectors, both of whom issue temporary tags for a state's department of motor vehicles. The inventive system allows real time record retrieval of vehicle and owner information from a temporary tag, and brings new efficiencies to motor vehicle dealers who have various compliance requirements with their states.

The inventive method and apparatus provides the same level of security for temporary license plate registration as is the case with permanent license plate registration. Motor vehicle dealers and government issuers of temporary tags can now provide law enforcement with registration information before a vehicle leaves their lot.

With the inventive system issuers of temporary tags electronically submit registration information to their state's department of motor vehicles. Within seconds, the registered license plate number is transmitted back to the issuer and printed on a registered temporary tag “shell” or blank that is electronically tracked from point of production to expiration.

The inventive tag apparatus includes security features that make the temporary tags virtually copy proof and are reflective for better night identification. The elimination of hand written information on the temporary tag also improves identification by law enforcement. Additional proprietary security features for the tag can be added that are only revealed to state and law enforcement authorities.

The inventive method provides an all-inclusive system that makes registration easier for issuers of temporary tags. With millions of temporary tags being issued each year, state motor vehicle departments can dramatically reduce their compliance enforcement costs by managing their data electronically instead of using costly paper reporting systems. Most importantly, law enforcement agencies will no longer have millions of unidentifiable vehicles on the road.

It is therefore an object of the present invention to provide a new and improved temporary tag or license plate.

It is another object of the present invention to provide a new and improved temporary tag with security features.

A further object or feature of the present invention is a new and improved method for issuing temporary tags.

An even further object of the present invention is to provide a novel temporary tag that permits real time record retrieval of vehicle and owner information.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of a registration screen that may be used to submit temporary tag application data to the inventive system;

FIG. 2 is an illustration of a dealer setup screen;

FIG. 3 is a plan view of a tag shell of the present invention; and

FIG. 4 is a plan view of a printed tag.

### DETAILED DESCRIPTION OF THE INVENTION

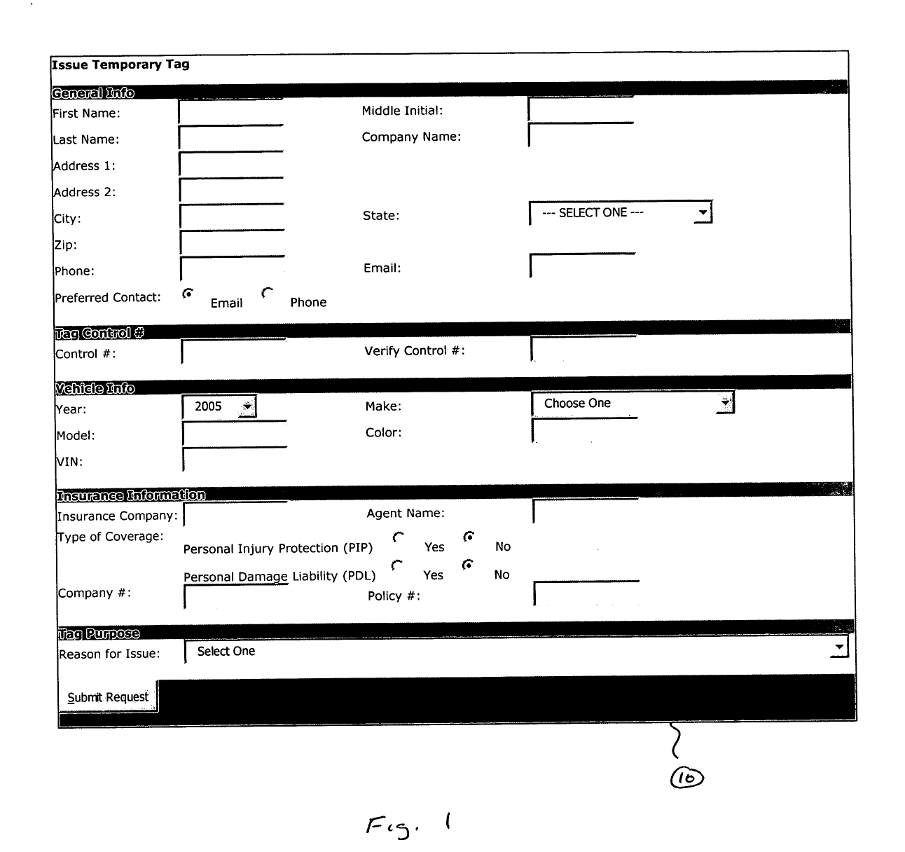

Referring to FIGS. 1 through 4, wherein like reference numerals refer to like components in the various views, there is illustrated therein a new and improved method and apparatus for the issuing of temporary license plates. The inventive method and apparatus provides a system for the immediate electronic registration of temporary motor vehicle tags (licenses). Government issuers and licensed motor vehicle dealers can electronically submit temporary tag application data via a password accessed Internet site. If all information is correct, a tag number will be generated and returned to the issuer from the state department of motor vehicles and printed on the tag shell at that time. FIG. 1 is an illustration of a registration screen 10 that may be used to submit the temporary tag application data.

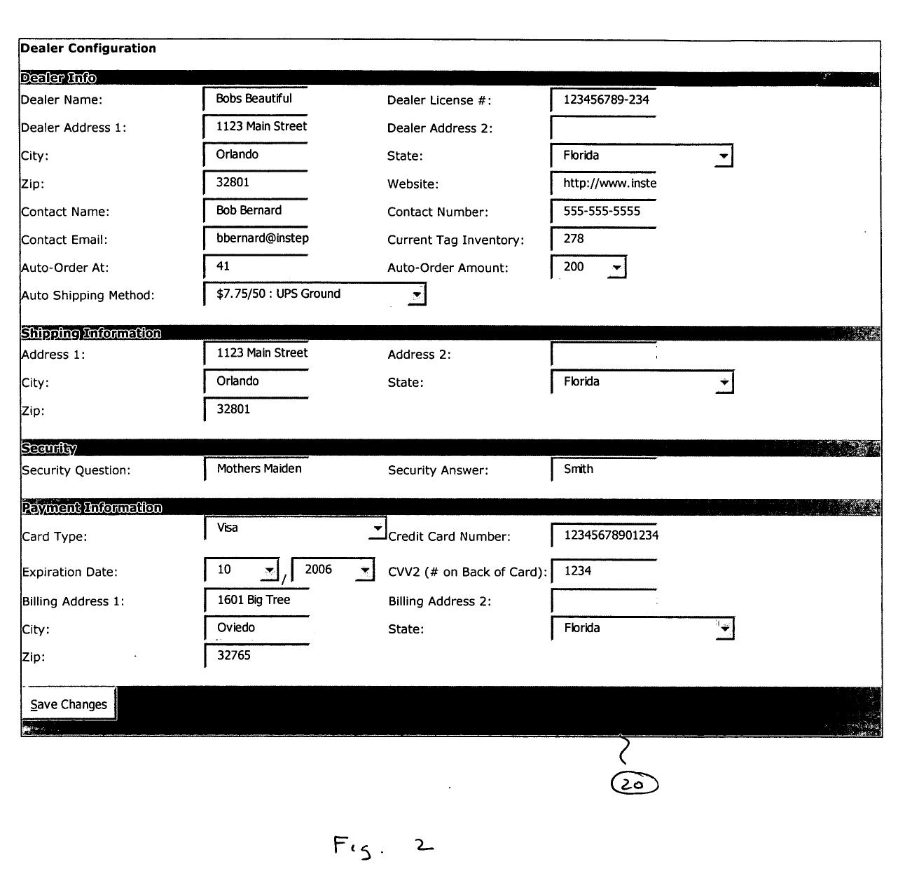

Licensed dealers and government issuers of tags first apply online for access to the system. FIG. 2 illustrates a dealer setup screen 20. In order to be allowed access, the motor vehicle dealer must be licensed and in good standing with their state's department of motor vehicles.

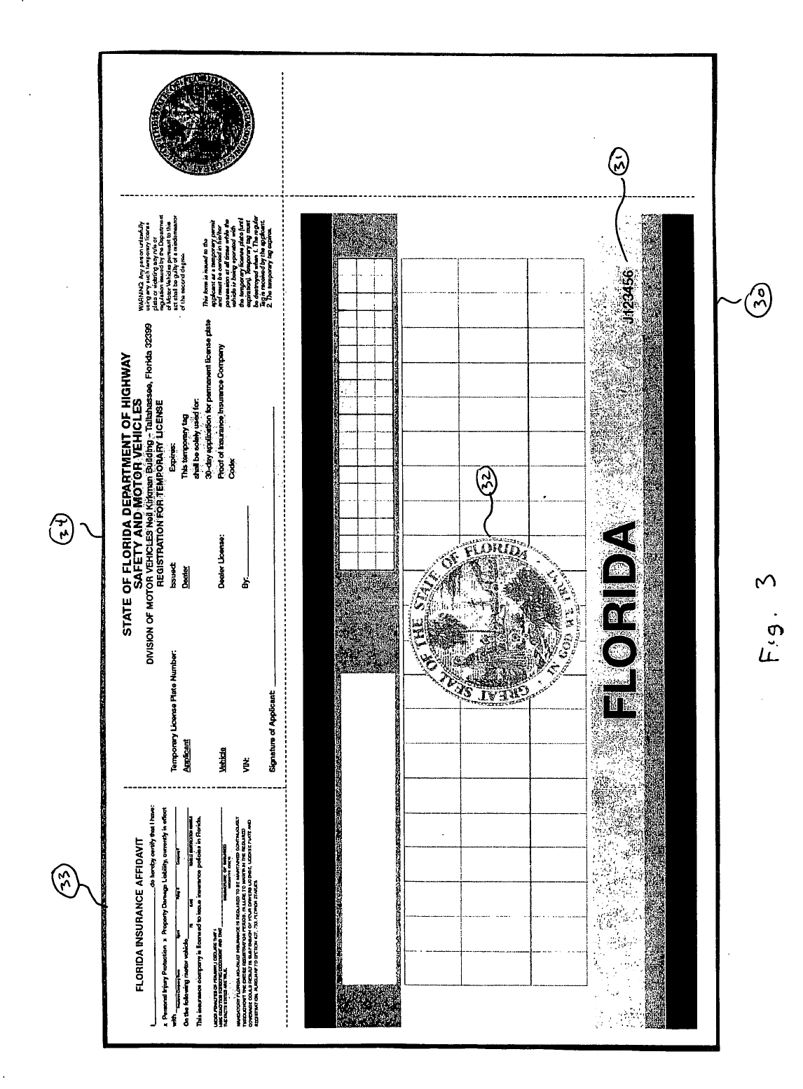

FIG. 3 illustrates a typical tag shell 30 (a tag without an assigned number or expiration date). Each tag shell 30 has a unique control number 31 which tracks it from point of production, to the dealership to which it is assigned, to the point of expiration to maintain an accounting of all tag shells in the system. The state or other emblem 32 may be holographic, which makes it reflective to head lights, and prevents copying or scanning. The tag shell 30 may also include an insurance card or affidavit 33, and a temporary registration card 34 corresponding to the temporary tag, for efficiency and convenience to the user.

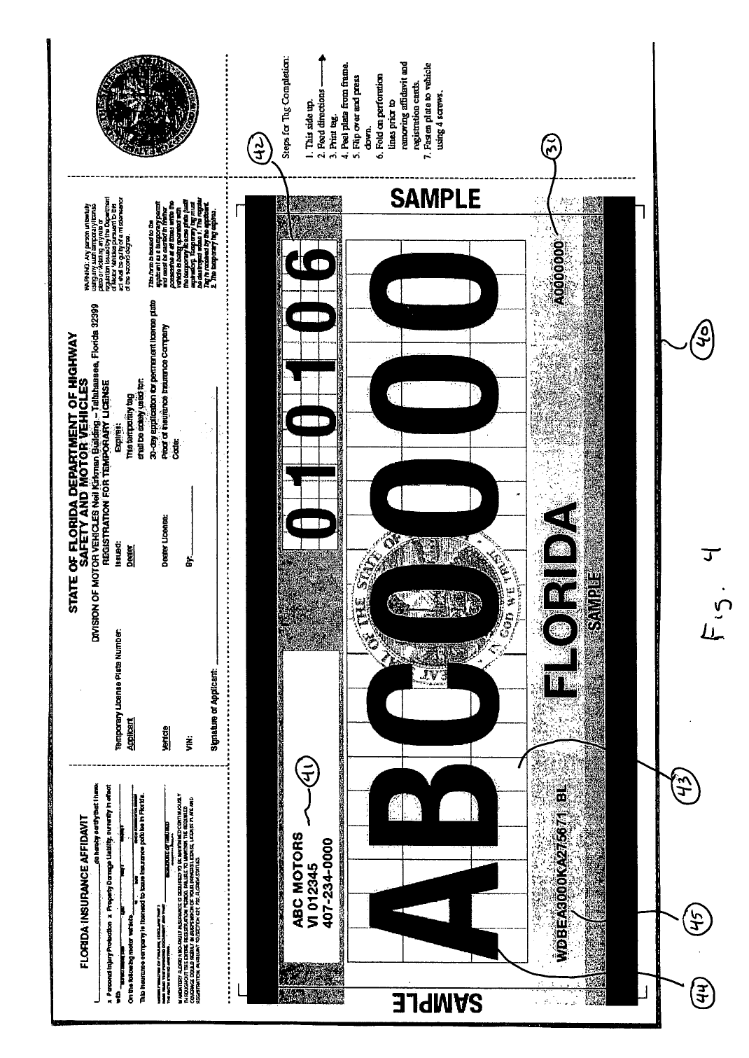

FIG. 4 illustrates a printed tag 40. Printed tag 40 may include dealership information 41, clearly visible expiration date 42, reflective background 43 that may also create a reverse reflective effect of some or all of the other indicia, alphanumeric license indicia 44 which may be printed in the form of a security font, and vehicle identification number alphanumeric indicia 45.

The printed tag 40 can also contain one or several other security features. For example, all temporary tags are registered in the NCIC database so law enforcement around the country can run them, and may include indicia so indicating. The control number 31 also can be used as a final authentication step to match the tag number with the control number.

In addition to being a tag printing and distribution system, the inventive system also allows motor vehicle dealers to electronically store data required by state department of motor vehicles so they will remain compliant with their record retention requirements. Its document repository system will store the bill of sale, financing agreements, lease agreements, odometer verification statements and any other stored reports.

Standard and custom reports can be generated to assist motor vehicle dealers with their compliance requirements. When a motor vehicle dealer requires a new shipment of tag shells, they log on to their account and place the order. An auto-order feature also allows them to place an automatic order when stock falls below a preset number.

Other features of the system include an auto notification system for customers to remind them of their upcoming expiration date. Notification can be made via email or an automated outbound calling system.

The inventive method may include any or all of various processes for use of the system. For example, the process for dealer registration may include the steps of: a licensed dealer or government issuer visits the system website; they click on the set up account option; they submit necessary information including dealer license number; the department of motor vehicles validates the license number and that the issuer is in good standing; a temporary user name and password is issued that they may modify later; an applet is downloaded to their computer that provides various security controls so that tags can only be printed from designated machines; and once downloaded and approved the new user sets up an account using a dealer configuration screen.

The process for issuing a tag may include the steps of: the issuer logs on using user name and password; at the dealer/government issuer menu the user selects “Issue New Tag”; the dealer/government issuer completes the electronic form, which preferably includes Name, Address, Phone, Email, Preferred Method of Contact, Tag Shell Control Number, Vehicle Information, Insurance Information, and Purpose for Temporary Tag; the dealer/government issuer electronically submits the request to the state DMV; if data is complete a tag number is generated at the state DMV and transmitted back to the dealer/government issuer where it can be printed a single time; and the tag then prints on the laser printer at the issuer's location.

The automated process for ordering tags may include the steps of: the dealer configuration screen determines at what stock count of tag shells an automatic reorder of tags are made (the reorder trigger and amounts can be changed at any point); and the issuer completes the screen and submits the order which is forwarded to the printer/mailer for shipment.

The manual process for ordering tags may include the steps of: the issuer logs on using user name and password; at the dealer/government issuer menu the user selects “Order Tag Stock”; the issuer then completes screen and submits the order which is forwarded to the printer/mailer for shipment.

The process for scanning and retaining documents may include the steps of: the issuer logs on using user name and password; at the dealer screen the issuer selects “Document Repository”; the issuer searches by name or VIN number; the issuer selects “Customer File”; the issuer scans documents; and the issuer inserts an electronic image under the appropriate file folder for each type of document.

The process of selection of reports may include the steps of: the issuer logs on using user name and password; at the dealer screen the issuer selects the type of report sought; once a report is selected the user defines the date range of report; and reports may be saved or printed.

The inventive method and apparatus improves the temporary tag distribution system for the state departments of motor vehicles in that records are updated in real time; tag shells are tracked from production to expiration; and data is managed which lowers the cost of compliance.

Tag issuers benefit in that registration and record management is accomplished in one process; most manual record storage is eliminated; compliance is made easier; turnkey system at a minimal cost; automatic order system for tag shells; and automatic notification of expiring temp tags.

Law enforcement benefits in many ways: improved homeland security; reduced car thefts, drug crimes and other violent offenses; elimination of counterfeit tags, improved officer safety; and assistance with the 4^{th} Amendment problems associated with temporary tags.

Insurance companies benefit in reduced claims of uninsured motorist, and reduced medical claims because of uninsured injuries.

State government benefits include increases in permanent registrations since the system can't be cheated any longer, and elimination of many illegal drivers, many of whom are uninsured.

Local government may benefit from increased sales taxes that go uncollected by cars that are never permanently registered, and the importance of motor vehicle records in solving crimes.

The inventive tag includes the option of adding RFID security chips. These small and in some versions undetectable chips allows law enforcement to obtain registrant information via radio transmission from the car tag to the patrol car. This added level of security assists in thwarting the counterfeiting of tags, quickly finds stolen tags and provides additional security for law enforcement before they approach a vehicle. This enables a specific tag number to be input in the inventive system when an “All Points Bulletin” is issued. It then sounds an alarm in a patrol car when that tag passes within the readable area of the patrol car.

This particular security feature could create privacy rights issues. Companies like Walmart, Best Buy, Albertson's and Target are leading the way in deploying security chips. Acceptance from the public, courts and legislators will determine the future uses of these devices in the public sector.

The inventive electronic registration system accommodates phone registrations as well. By calling a system customer service representative or interactive voice response system, a tag issuer can verbally provide a user system with the state required information to register the temporary tag. The customer service representative inputs the required information into the online system and upon system approval, verbally gives that information to the issuer who then writes the state required information on the tag shell. The exact information is determined by the state but at a minimum should include the tag registration number and the expiration date.

For states that wish to issue temporary tags with the registration numbers preprinted on them instead of a blank tag shell, the inventive system provides an online registration system without the print on demand feature. The issuer instead follows the current state process for issuing the tag but registers it with the appropriate state agency through the online system following issuance of the tag.

The inventive method also allows for phone registration of temporary tags with registration numbers preprinted on them. The issuer calls either a customer service representative or interactive voice response system and verbally registers the temporary tag over the phone. The issuer follows the current state process for issuing the tag but registers it with the appropriate state agency via the customer service representative or interactive voice response system following the issuance of the tag.

An alternate embodiment of the inventive temporary tag provides a tamper resistant/weather resistant temporary tag shell. The inventive tag shell is mounted with a laminated sheet on the back. A non-stick coating is applied to the back of the tag shell that allows for the removal of the tag shell from the adhesive without damaging the tag shell.

The tag number, expiration date and other temporary registration and insurance information may be printed on the tag shell at the time of electronic registration.

Once printed the tag shell is pealed from the laminate backing. It is then flipped, adhering the face of the now printed temporary tag to the clear laminate. The front surface does not have a non-stick coating. This permanently affixes the printed shell to the laminate. Removal of the face of the tag from the laminate destroys it.

In addition to creating a tamper resistant tag, the face of the tag is protected from moisture and the other elements common in typical road conditions. It increases the rigidity of the tag improving its performance against wind resistance and causes the destruction of the tag if it is pulled from the screws that mount it in the plate holder. Removal requires the same effort as a permanent metal plate.

Since the tag number is now registered, it can be run just like a permanent plate making theft of the tag no more attractive to a criminal than stealing a permanent license plate. This tamper resistant/weather resistant temporary tag also eliminates the need to mount temporary tags inside the rear window of vehicles.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A temporary license plate comprising:
a printed tag bearing dealership information, expiration date, a reflective background, alphanumeric license indicia, and vehicle identification number alphanumeric indicia.

2. A method for issuing temporary license plates, said method comprising the steps of:
logging the issuer on to a computer network using a user name and password;
requesting the issue of a new tag;
completing an electronic form;
submitting the request to the state DMV;
generating a tag number at the DMV and transmitting it back to the issuer; and
printing the temporary license plate at the issuer's location.
